(19) United States
(12) Patent Application Publication
(10) Pub. No.: US 2009/0199762 A1
(43) Pub. Date: Aug. 13, 2009

(54) EMERGENCY SIGNALING APPARATUS AND METHOD

(76) Inventor: Jacqueline Elam, Ladera Ranch, CA (US)

Correspondence Address: MICHAEL A. SHIPPEY, PH. D., 4506 S. La Palma Avenue, Anaheim, CA, 92807, US

(21) Appl. No.: 12/028,903

(22) Filed: Feb. 11, 2008

(51) Int. Cl. B60Q 1/52; G09F 17/00

(52) U.S. Cl. 116/28 R; 116/173

(57) ABSTRACT

A display device to indicate a private emergency, such as an expectant mother in labor, is disclosed. The device is displayed on the outside surface of a moving automobile. Motorists will yield to the auto, and police officers are alerted to offer assistance as necessary to escort the auto to a hospital.

### BACKGROUND OF THE INVENTION

The field of the present invention is emergency signaling and devices to accomplish the same.

The use of signage to indicate the condition of a transitory vehicle is well known in the art. For example, Rabkin, U.S. Pat. No. 5,502,909, discloses a sign to display distress signals for alerting passing motorists. On seeing the sign, it is hoped that a passing motorist will summon an appropriate emergency response. Indeed, Rabkin shows several versions of the distress displays such as a sign to request the police, a sign to request the fire department, a sign to request a tow truck, or a sign to request an ambulance. Thereby a passing motorist would know what type of assistance is needed and summon such assistance to the disabled transitory vehicle.

Also well known in the art are various methods to attach distress signage to a transitory vehicle. For example in Rabkin, discussed above, distress signage is secured to a stopped vehicle or the vehicle's window using a suction cup. In Panossian, U.S. Pat. No. 5,249,381, distress signage is clipped to the top of a lowered side window with the signage extending perpendicularly from the window.

The prior art thus discloses structures and methods for a person to display signage proximate a disabled transitory vehicle that encourages a passing motorist to summon an emergency response. Furthermore, today it is common for drivers to have portable or cellular telephones. Drivers may thereby easily summon emergency help by calling an emergency number such as 911 or the Highway Patrol and indicate the location of an emergency site. For example, drivers may see a vehicle parked on the shoulder of a road, assume assistance is needed, and summon help to that site. In other circumstances, a driver may not have access to a portable telephone. However, call boxes are now installed on many freeways whereby a driver may stop and immediately contact an emergency organization such as the Highway Patrol. In such a situation the driver may see a stalled vehicle, assume help is needed, and drive ahead to a call box and contact authorities.

However, when a person is in an emergency situation, it is not always the case that the person is in a stationary position, awaiting a response from a skilled emergency response team. Rather, it is frequently the case that the person is a passenger in a vehicle, or indeed even the driver thereof, proceeding to a hospital or other destination providing treatment for the emergency condition. If the person suffering the emergency is fortunate enough to be transported in an official vehicle, such as an ambulance, police car, or fire truck, that is equipped with siren and colored lights, the emergency vehicle is allowed the right-of-way by other vehicles to pass through unobstructed. Although there are laws prohibiting blocking the right-of-way of emergency vehicles, in practice these laws are seldom invoked. Almost all persons are willing to pull aside to avoid blocking the emergency vehicle, whether from admirable concern for the wellbeing of unknown strangers, or for the very prudent concern that the emergency vehicle is in extremis, and may present hazards to other vehicles that do not avoid blocking passage to the emergency vehicle.

Frequently, however, a person in an emergency situation is traveling, not in an official vehicle, but in a private car. There are many examples of this. To name but a couple, a expecting mother goes into labor, and her husband, or another family member or friend, is present to drive her to the hospital to deliver her baby. Or, a mother calls her doctor because her child is sick or injured, and the doctor instructs her to bring the child immediately to the doctor's office, or the emergency room at the hospital. In these and many other types of common situations, the sufferer of an emergency situation is being transported to safety and treatment in a private vehicle.

In this situation, the vehicle is not recognized by surrounding motorists as harboring an emergency situation. Passing motorists normally will not treat the vehicle with the deference they treat an emergency vehicle. They are not expected to do so, for they have no notice or identification of the vehicle as harboring an emergency. Thus, especially in a time-sensitive emergency or a crowded roadway, the vehicle may experience significant delays in reaching its destination, delays that would not impede an official emergency vehicle.

Thus, it would be highly desirable to have a new and improved device and method which would allow for swift passage of a private vehicle in an emergency situation; which would not place the suffering motorist in jeopardy; and which would not cause the emergency response communication system to become clogged with unnecessary calls. Additionally, such a device and method should not cause a great disruption to the normal flow of traffic.

### SUMMARY OF THE INVENTION

Therefore it is a principal object of the present invention to provide a new and improved device and method which can be used to assist a motorist in transit, suffering an emergency, without placing the motorist in jeopardy, and without causing unnecessary and unwanted clogging of the emergency response communication system.

Briefly, the above and further objects of the present invention are realized by providing a kit for allowing a person to demonstrate to observers that an emergency is present in the vehicle, and observers should treat the vehicle as an ambulance or other emergency response vehicle, and admit through passage to the vehicle on its journey to a hospital or similar destination.

The present invention includes a device and method wherein indicia are positionable on the surface of a vehicle, or within the vehicle yet visible from the outside, said display area being visible to an observer of the vehicle. The indicia communicate a message to the observer to encourage the observer to avoid the vehicle, and treat it as an ambulance or other emergency response vehicle, and admit through passage to the vehicle on its journey to a hospital or similar destination.

Several features of the invention allow the indicia to be observable at night. For example, the indicia may include reflective tape, which is visible when lighted by streetlights, auto headlights, or other night lighting. Further, in one preferred embodiment of the current invention, the indicia are lighted by lights contained on the device on which the indicia are mounted, for example, as lights on a flagpole so disposed as to provide lighting of the flag displaying the indicia.

A kit is also provided to notify others of the status of an emergency situation. The kit comprises a display support, a first display attachable to the display support with indicia for encouraging the treatment of the vehicle as an emergency vehicle, optional second display similarly attachable, and stowage of said display and indicia when the need for such treatment has passed.

### BRIEF DESCRIPTION OF DRAWINGS

The above mentioned and other objects and features of the invention herein described and claimed, and the manner of attaining the objects will become apparent, and the invention itself will be best understood by reference to the following description of a preferred embodiment of the invention in conjunction with the accompanying drawings, wherein:

FIG. 1 is a perspective representation of a car in transit, having flag signage displayed in accordance with a preferred embodiment of the present invention.

FIG. 2 is a perspective representation of a car in transit, having flag signage stowed in accordance with a preferred embodiment of the present invention.

FIG. 3 is a perspective representation of a car in transit, having flag signage displaying a woman in labor, proceeding to the hospital, in accordance with a preferred embodiment of the present invention.

FIG. 4 is a plan view of a flagpole for supporting an emergency flag, in accordance with a preferred embodiment of the present invention.

FIG. 5 is a front view of flag signifying an emergency in accordance with a preferred embodiment of the present invention; and having indicia to indicate caution due to an emergency vehicle proceeding to medical care, such as at a hospital.

FIG. 6 is a diagrammatic front view of the storage cover in place to cover the emergency flag when not in active use, in accordance with a preferred embodiment of the present invention.

FIG. 7 is a front view of flag signifying an emergency in accordance with a preferred embodiment of the present invention; and having indicia to indicate caution due to an emergency vehicle carrying a woman in labor, proceeding to medical care, such as at a hospital.

FIG. 8 is a perspective representation of a car in transit, having flag signage displaying a woman in labor, proceeding to medical care, in accordance with a preferred embodiment of the present invention. The car is preceded by another vehicle, which is pulling over to allow the signed car to proceed.

FIG. 9 is a perspective representation of a car in transit, having flag signage displaying a woman in labor, proceeding to the hospital, in accordance with a preferred embodiment of the present invention. A police cruiser, notified by the signage, escorts the signed car.

FIG. 10 is a front view of a preferred embodiment of the kit of the current invention, containing all elements of the display materials of the present invention.

FIG. 11 is a front view of the flag of a preferred embodiment of the current invention, signifying an emergency in accordance with the present invention, emphasizing the presence of the reflective tape comprising the borders around the message indicia.

### DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

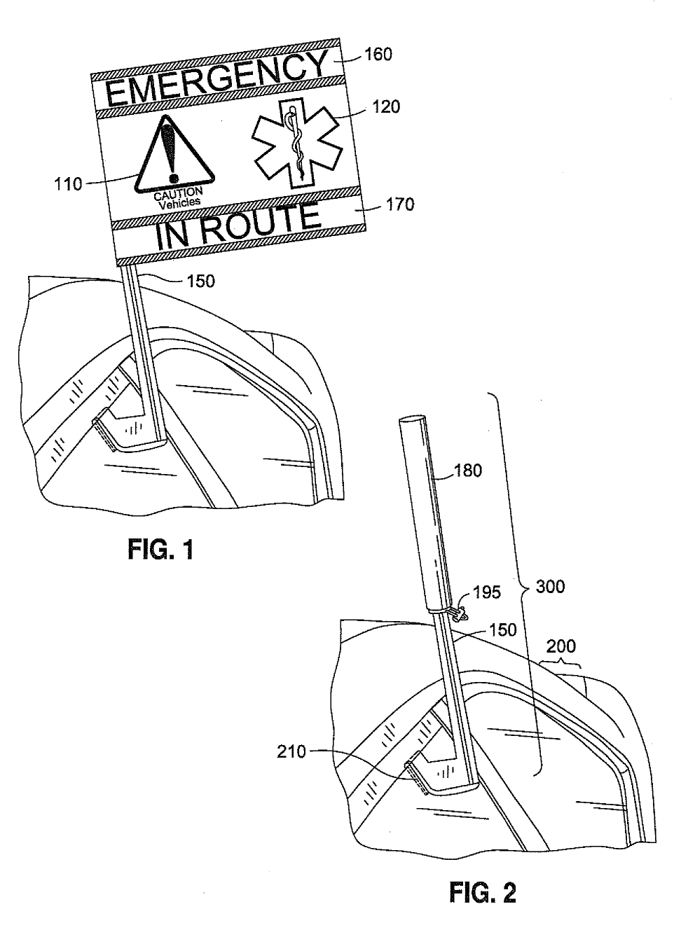

Referring to FIG. 1, a flag 100 constructed in accordance with the present invention is depicted on a vehicle in transit 200. The moving vehicle 200 is moving along a road while other vehicles continue to pass by in either direction. The driver and any passengers in the passing cars may be observers of the transitory vehicle 200. The indicia 160 on the flag 100 communicate a message to these observers that the observers should treat the transitory vehicle 200 as an emergency vehicle, such as an ambulance, and respond accordingly to the vehicle 200. Although not shown in FIG. 1, another flag having indicia to encourage the like response an emergency-carrying vehicle in motion may alternatively be displayed.

To better understand the advantages of using the flag 100, FIG. 1 displays several likely messages communicated by the vehicle in need of passage assistance. The flag 100 carries several visible indicia. As displayed in FIG. 1, those indicia include emergency sign 160, caution sign 110, caduceus or hospital indicator 120, and emergency notifier 160, on board the instant vehicle enroute as shown by indicia 170. The flag 100 is viewable by passing motorists so that the various indicia communicate to any observer that an emergency response is desired, simply to promote transit of the vehicle.

FIG. 1 shows a flagpole 150 attached to a side window 210 of the car 100. The flagpole 150 may simply clip to the window or the windowsill, or may have a separate clamping mechanism. Those in the art will readily recognize that several alternatives exist to attach the flagpole 150 to the side window 210. The pole 150 extends up and away from the vehicle A flag 100 is attached to the pole such that the flag 100 extends substantially perpendicular to the pole and is positioned such that those observing the emergency vehicle may read the indicia on flag 100.

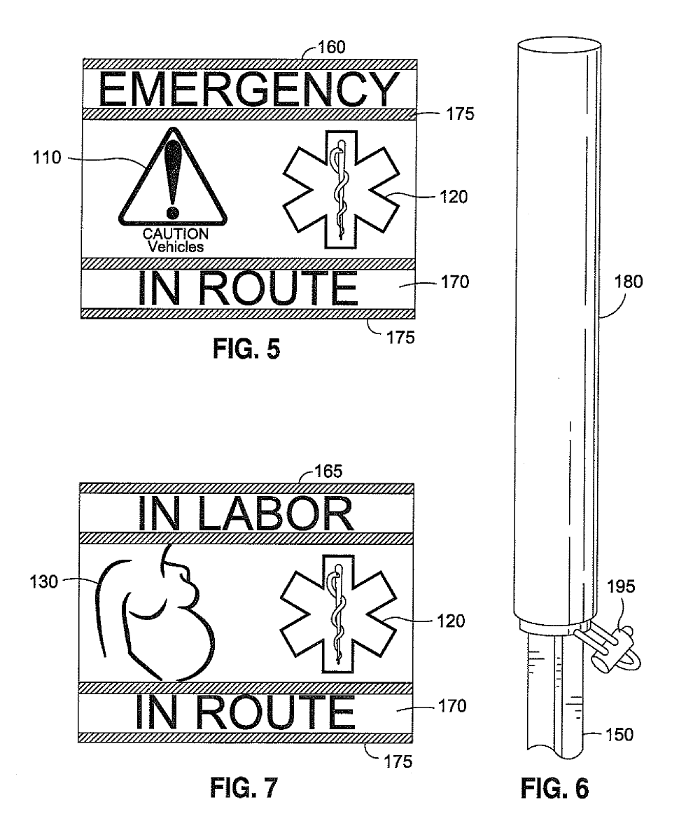

The flag 100 may have indicia 160 to indicate that an emergency is in progress. The flag 100 further may have indicia 110, having an exclamation mark within a triangle symbol, and captioned: CAUTION Vehicles. The exclamation mark within a triangle symbol is internationally known to mean “Caution.” Therefore the indicia 110 shown in FIG. 1 symbolically displays to observers they are requested to avoid blocking the vehicle, and admit it to through passage on its way to its destination. Additionally, the flag 100 may have further indicia, such as 175, indicating that the vehicle is en route. Also, indicia 120 may be displayed, to indicate that the vehicle's destination is a hospital or similar provider of medical treatment services. Those skilled in the art will readily recognize that several alternatives exist for indicia that will successfully encourage outside vehicles to make way for the vehicle in emergency. The flag 100 is most conveniently provided as part of a kit. A detailed view of this version of the flag 100, and indicia thereupon, is visible in FIG. 5.

FIG. 2 shows the flag 100 in stowed configuration, as a component of kit 300. Kit 300 is designed to be conveniently carried in a vehicle. The kit 300 contains at least one flag such as the first flag 100 illustrated in the previous FIG. 1. The flag is shown in FIG. 2 in a stowed position, inside flag container 180. Container 180 may be a hard canister, or it may be a soft cover of leather or synthetic leather-like construction. The container is held in place over the flag with latch 195. The entire assembly can be left outside the window in display position, or it can be stored in the trunk or other convenient location inside the vehicle when not in use. Details of the stowed configuration are displayed in FIG. 6.

The kit 300 further contains a pole 150 wherein the pole 150 may be telescoping or made in sections such that the pole 150 conveniently collapses, folds, or disassembles for easy storage, such as many tent poles. The kit 300 may also contain a window bracket to support the pole 150. In the preferred embodiment, however, the pole 150 and bracket 154 are a single-piece of construction.

The window bracket will attach to a side window and is adapted to hold and support the pole 150. The flag 100 is then positionable on the pole 150 so that, when removed from the container, the indicia on the flag are visible to the moving cars 2.

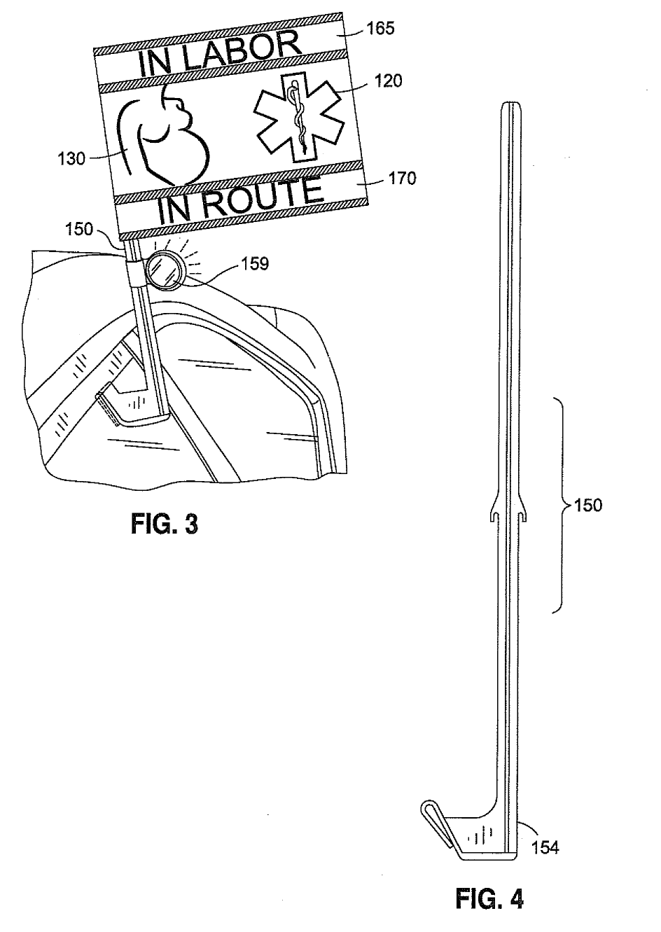

FIG. 3 shows another preferred embodiment of the present invention. In this figure, a new flag is shown with different indicia. Here, the cause for travel is a woman in labor, as suggested by indicia 165 in words, and 130 in the form of a pictorial representation of a pregnant woman. Again, the message to nearby vehicles is clear: Please avoid this vehicle, and allow it to pass through as if an official emergency vehicle, transporting a woman in labor to a hospital to give birth under medical care. Details of this version of the emergency flag are depicted in FIG. 7.

FIG. 4 is a plan view of a flagpole 150 for supporting an emergency flag, in accordance with a preferred embodiment of the present invention. The lower portion of the pole includes a foot 153 for attachment of the flagpole to a window of an automobile.

FIG. 5 is a front view of flag 100 signifying an emergency in accordance with a preferred embodiment of the present invention; and having indicia to indicate caution due to an emergency vehicle proceeding to medical care, such as at a hospital. At the top edge of the flag 100 is found indicia 160 indicating an emergency in progress. Bordering the top edge of flag 100 and underneath indicia 160 are border bars 175. These bars 175, in a preferred embodiment, are comprised of reflective material, such as reflective tape. In the central area of the flag 100 are indicia 110 and 120. Indicia 110 display a request for vehicles to avoid blocking the subject vehicle displaying flag 100, and indicia 120 indicate the subject vehicle's destination is to a source of medical care, such as a hospital. Still lower, at the bottom area of flag 100, is found indicia 170, indicating that the vehicle is enroute to the destination. Indicia 170 are bordered at top and bottom by border bars 175, which may be comprised of reflective material.

FIG. 6 is a diagrammatic front view of the storage cover in place to cover the emergency flag when not in active use, in accordance with a preferred embodiment of the present invention. Flag 100 and flagpole 150 are enclosed within sheath 180. Such storage protects the flag from dirt and damage when not in use. An optional lock 195 secures the flag and flagpole within the storage sheath 180.

FIG. 7 is a front view of flag signifying an emergency in accordance with a preferred embodiment of the present invention; and having indicia to indicate caution due to an emergency vehicle carrying a woman in labor, proceeding to medical care, such as at a hospital. The cause for travel, a woman in labor, is suggested by indicia 165 in words, and indicia 130 in the form of a pictorial representation of a pregnant woman. The message to nearby vehicles is clear: Please avoid this vehicle, and allow it to pass through as if an official emergency vehicle, transporting a woman in labor to a hospital to give birth under medical care. Indicia 170 indicate that the vehicle is enroute to the destination. Indicia 170 are bordered at top and bottom by border bars 175, which may be comprised of reflective material.

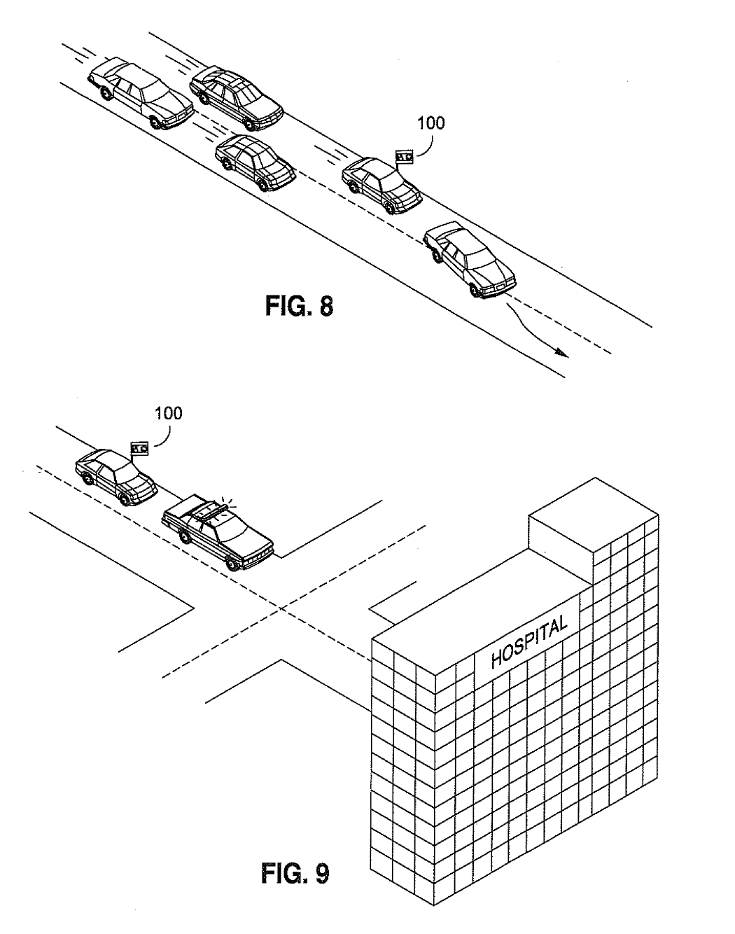

FIG. 8 is a perspective representation of a car in transit, having flag signage displaying a woman in labor, proceeding to medical care, in accordance with a preferred embodiment of the present invention. The car is preceded by another vehicle, which is pulling over to allow the signed car to proceed.

FIG. 9 is a perspective representation of a car in transit, having flag signage displaying a woman in labor, proceeding to the hospital, in accordance with a preferred embodiment of the present invention. A police cruiser, notified by the signage, escorts the signed car.

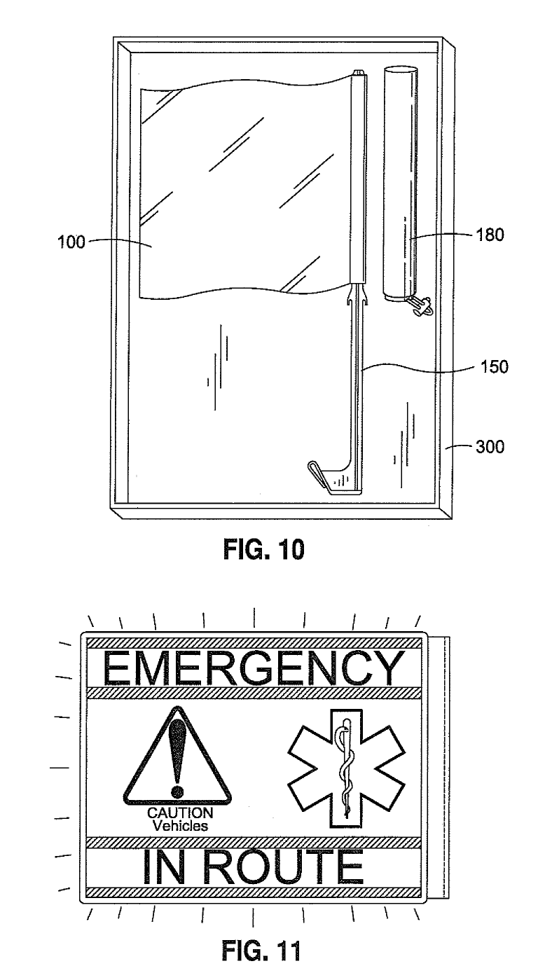

FIG. 10 is a front view of a preferred embodiment of the kit 300 of the current invention, containing all elements of the display materials of the present invention. Included within the kit are two examples of flag 100; flagpole 150; and sheath 180. The kit can be closed and stored in the trunk of the car, or other secure location, when use of the present invention is not required.

FIG. 11 is a front view of the flag of a preferred embodiment of the current invention, signifying an emergency in accordance with the present invention, emphasizing the presence of the reflective tape 170 comprising the borders around the message indicia. Flag 100 is constructed from a sheet material, preferably cloth, but plastic, paper, cardboard or other sheet-forming material is acceptable. The indicia are printed on the sheet material, although those skilled in the art will recognize that the indicia may be applied to the sheet material by other processes such as plastic transfer or paint. One edge of the flag 100 will have means for receiving the top end of the pole 150.

In use, the flag 100 may initially be removed from the container, and mounted on pole 150 to display while the vehicle is in transit to a destination. Nearby traffic will be notified to assist the occupants of the vehicle in an appropriate way. One encourages response is simply to pull over to allow the vehicle to pass through. Alternatively, the flag 100 may encourage an observer to contact the police or highway patrol to report the emergency. Such contact will likely occur via cell phone, although roadside telephones, CB radios, and other communication means are available to at least some if not most observers. Police thus summoned would be immediately aware of the emergency and the situation around it, and could gauge whether a police escort would be appropriate.

It is not intended that the use of the present invention will permit the driver of the vehicle displaying the emergency flag to exceed the speed limit, or otherwise drive outside the limits imposed by law. The flags are informational, designed to help a person in an emergency and to inform the observers of their need to treat the flag-displaying vehicle as an emergency in progress.

One limitation of the flag means of communication is that it may suffer from poor visibility at night. The present invention comprises means of illumination of the flag, to increase visibility at night. One means would employ battery powered mini-flood lamps aimed at the flag. Such flood lamps may be attached to the flagpole 150, or directly to the outside of the vehicle. The lights could be battery-powered or run through a transformer to plug into the vehicle electronic circuit.

Another means of illumination contemplated is to include lights as a physical component of the flag. This could best be accomplished by attaching low power LED lights to critical areas of the flag. Thus, perhaps EMERGENCY is illuminated. As in the flood lighting, lights could be battery-powered or run through a transformer to plug into the vehicle electronic circuit.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An emergency signaling method to encourage observers of a vehicle in transit to avoid the vehicle and allow passage to the vehicle to assist a motorist or passenger within said vehicle requiring such assistance, comprising the steps:
positioning means for displaying information outside the vehicle in transit, so that the observers see said means for displaying information;
displaying first means for communicating information on said means for displaying information to communicate a message to the observers encouraging the observers to allow passage to the vehicle;
said vehicle thereby passing through traffic at an increased rate relative to other vehicles;
said vehicle thereafter reaching its destination; and,
storing means to secure said communication means after the need has passed.

2. The emergency signaling method of claim 1 where the means for displaying information is a pole fastenable to a car window and sill.

3. The emergency signaling method of claim 1 where the means for communicating information is disposed on a flag attached to the free end of said pole.

4. The emergency signaling method of claim 3 further comprising reflective tape affixed to selected display areas of said flag.

5. The emergency signaling method of claim 1 further comprising illumination means to make said communication means visible at night.

6. The emergency signaling method of claim 1 where the means for communicating information is selected from the group: a flag indicating that a pregnant woman is en route, a flag indicating that vehicles nearby should exercise caution, and a flag indicating that the vehicle is enroute to a hospital.

7. The emergency signaling method of claim 1 further including one or more cautionary warning messages displayed within said communication means.

8. The emergency signaling method of claim 7 wherein said cautionary warning messages are selected from the group: emergency, in labor, in route, enroute.

9. The emergency signaling method of claim 1, further comprising a kit, transportable in an automobile, wherein said kit comprises all the elements needed to mount and display the indicia of claim 1.

10. An emergency signaling method to encourage observers of a vehicle in transit to avoid the vehicle and allow through passage to the vehicle, to assist a motorist or passenger within said vehicle requiring such assistance, comprising the steps:
determining that vehicle occupants require and should rapidly reach an emergency response destination;
selecting a first flag having indicia providing a message that an emergency is in progress, and that the vehicle occupants require fast transit to a hospital, doctor, or other emergency response provider;
positioning said flag on a pole attached to the vehicle, so that the observers see the first flag;
providing illumination of the flag, if conditions require such illumination;
proceeding to the destination for treatment of the emergency condition; and,
stowing said flag away from display following the emergency treatment.
